(19) United States
(12) Patent Application Publication
(10) Pub. No.: US 2015/0186911 A1
(43) Pub. Date: Jul. 2, 2015

(54) PRODUCT RE-PRICING SYSTEMS AND RELATED METHODS

(71) Applicant: Viesoft, Inc., San Francisco, CA (US)

(72) Inventor: Anthony Vierra, San Francisco, CA (US)

(21) Appl. No.: 14/586,201

(22) Filed: Dec. 30, 2014

Related U.S. Application Data
(60) Provisional application No. 61/922,622, filed on Dec. 31, 2013.

(51) Int. Cl. G06Q 30/02; G06Q 10/08

(52) U.S. Cl. CPC G06Q 30/0206; G06Q 10/087

(57) ABSTRACT

A computer system that is configured for displaying (e.g., on an electronic display associated with a particular product in a brick-and-mortar store) a first price for the particular product. The system monitors one or more competitor websites for competing prices, adjusts the first price to a second price if the competitor's pricing for the particular product differs from the first price and updates the first price to the second price on the electronic display. In various embodiments, adjusting the first price to the second price occurs substantially automatically. In some embodiments, the system tracks price change trends of competitors for one or more products and determines a predicted price change prior to an actual competitor price change. In some embodiments, the system changes one of the first price or the second price to the predicted price prior to an actual price change by the competitor.

### CROSS-REFERENCE TO RELATED APPLICATIONS

This patent application claims priority from U.S. Provisional Patent Application 61/922,622, entitled “Product Re-Pricing Systems and Related Methods”, which was filed on Dec. 31, 2013, which is hereby incorporated herein by reference in its entirety.

### BACKGROUND

In general, brick-and-mortar retail stores must physically adjust prices for any products that require the price to be changed. Typically, it is not possible to substantially automatically change all of the prices for a particular product in a brick-and-mortar retail store. In addition, re-pricing a particular product takes significant time and effort for a brick-and-mortar retail store. Also, once a brick-and-mortar retail store re-prices a particular item, it is difficult to again change the price for that particular item without expending additional time and effort.

### SUMMARY

In general, in various embodiments, a computer system includes at least one processor, wherein the computer system is configured for: (1) displaying, on a display associated with a particular product in a brick-and-mortar store, a first price for the particular product; (2) determining one or more competing prices for the particular product; (3) adjusting the first price to a second price based at least in part on the one or more competing prices; and (4) displaying, on the display associated with the particular product in the brick-and-mortar store, the second price for the particular product.

In an illustrative embodiment, a computer-implemented method of adjusting a price for a particular product includes (1) displaying, by a processor, on one or more displays in a brick-and-mortar retail store, a price for a particular product offered for sale in the brick-and-mortar retail store; (2) receiving, by a processor, pricing information for the particular product, the pricing information comprising one or more competing prices for the particular product; (3) adjusting, by a processor, the price for the particular product based at least in part on the one or more competing prices; and (4) updating the price for the particular product in at least one of: (i) a database of pricing information for one or more products offered for sale in the brick-and-mortar retail store; (ii) the one or more displays in the brick-and-mortar retail store; and (iii) one or more advertisements for sale of the particular product associated with the brick-and-mortar retail store.

In an illustrative embodiment, a non-transitory computer-readable medium stores computer-executable instructions for: (1) adjusting a price for a particular product offered for sale at a brick-and-mortar retail store based at least in part on one or more factors selected from a group consisting of: (i) one or more competing prices for the particular product; (ii) sales information associated with the particular product; and (iii) geographic information associated with the brick-and-mortar retail store; and (2) displaying the adjusted price on one or more displays associated with the particular product in the brick-and-mortar retail store.

### BRIEF DESCRIPTION OF THE DRAWINGS

Various embodiments of a system and method for pricing products are described below. In the course of this description, reference will be made to the accompanying drawings, which are not necessarily drawn to scale, and wherein:

FIG. 1 is a block diagram of a product pricing server in accordance with an embodiment of the present system;

FIG. 2 is a schematic diagram of a computer, such as the product pricing server of FIG. 1, that is suitable for use in various embodiments;

FIG. 3 depicts a flow chart that generally illustrates various steps executed by a product re-pricing module that, for example, may be executed by the product pricing server of FIG. 1;

FIG. 4 depicts a flow chart that generally illustrates various steps executed by an updating re-pricing module that, for example, may be executed by the product pricing server of FIG. 1; and

FIG. 5 depicts a flow chart that generally illustrates various steps executed by a factor-based re-pricing module that, for example, may be executed by the product pricing server of FIG. 1.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A system for re-pricing one or more products, in various embodiments, is configured to substantially automatically adjust a price of a particular product based at least in part on one or more prices charged by other retailers for the same (or a similar) particular product. In particular embodiments, the system is configured for: (1) determining one or more competing prices for a particular product; (2) adjusting a price charged for the particular product at one or more brick-and-mortar retail locations based at least in part on the competing prices; and (3) updating the price for the particular product on one or more electronic displays associated with the particular product, in a pricing database for the one or more brick-and-mortar retail locations, and/or in one or more advertisements for the particular product.

In particular embodiments, the system comprises a plurality of electronic product pricing displays at one or more brick-and-mortar retail locations, which may, for example, comprise one or more product pricing displays located adjacent product displays or shelving within the one or more brick-and mortar retail locations. In various embodiments, the one or more displays may include any suitable display such as, for example, one or more LED displays, one or more LCD displays, one or more Plasma displays, etc. In particular embodiments, the one or more displays are configured to receive and display pricing and other product information for one or more particular products, which may, for example, be positioned adjacent the one or more displays within the brick-and-mortar retail stores. In various embodiments, the one or more displays are configured to receive the pricing and product information via any suitable wireless protocol, such as, for example, WI-FI, Bluetooth, Near Field Communication, Low Energy Bluetooth, etc.

In particular embodiments, the system is configured to substantially automatically adjust a price for a particular product and then: (1) display the updated price on any of the one or more displays associated with the particular product in the brick-and-mortar retail store; (2) update the price associated with the particular product in a pricing database associated with the brick-and-mortar retail store; and/or (3) update any advertisements to reflect the adjusted price (e.g., update any web advertisements for in store prices, send one or more electronic messages to one or more customers of the brick-and-mortar retail store advising them of the price change, etc.).

In various embodiments, the system is configured to adjust the price for the particular product based at least in part on: (1) one or more competing prices for the particular product (e.g., one or more prices charged by one or more competitors for the particular product); (2) sales of the particular product (e.g., the system may substantially automatically adjust a price lower for a poorly selling product or higher for a best-selling product in order to increase anticipated sales and/or profits; (3) one or more geography-specific considerations associated with the location of the brick-and-mortar retail store (e.g., the system may substantially automatically adjust the price for a particular product based on weather conditions near the brick-and-mortar retail store, based on a season such as winter or summer that the area around the brick-and-mortar retail store is currently experiencing, etc.); (4) sales and/or pricing information for one or more products that are substantially similar to the particular product (e.g., products having similar features that are of a different brand, etc.); and/or (5) any other suitable factor. In particular embodiments, the system is further configured to facilitate a transaction between the brick-and-mortar retail store and customer for the particular product at the adjusted price.

In embodiments in which the system is configured to adjust the price of the particular product based at least in part on the one or more competing prices, the system may be configured to receive the one or more competing prices using any suitable technique. In a particular embodiment, the system is configured to identify product listings for the particular product and derive pricing information from the product listings using the techniques described in U.S. patent application Ser. No. 14/145,474, entitled “Product Matching Systems and Related Methods,” filed Dec. 31, 2013, which is hereby incorporated by reference in its entirety. In various embodiments, the system may be further configured to display the one or more competing prices on the one or more electronic displays along with the price for the particular product (e.g., to convey to customers that the particular product can be purchased at the brick-and-mortar retail store for a price that may be competitive with other retailers such as online retailers).

In various embodiments, the system is configured to enable a user to provide one or more re-pricing rules that the system may use to adjust the price of the particular product. For example, the user may provide one or more re-pricing rules that include: (1) a rule to match the lowest competing price; (2) a rule to adjust the price to within a particular amount of the lowest competing price; and/or (3) any other suitable re-pricing rule.

In particular embodiments, the system is configured to adjust the price of the particular product according to a particular, pre-determined schedule (e.g., hourly, weekly, daily, monthly, every minute, etc.). In other embodiments, the system is configured to adjust the price of the particular product at least partially in response to a request from a user associated with the brick-and-mortar retail store. In still other embodiments, the system is configured to adjust the price of the particular product substantially continuously (e.g., continuously).

In various embodiments, the system is configured to adjust the price for the particular product at a single brick-and-mortar retail store. In other embodiments, the system is configured to adjust the price at a plurality of retail stores (e.g., a plurality of retail stores in a particular geographic area). In still other embodiments, the system is configured to adjust the price at all brick-and-mortar retail stores controlled by a particular entity.

In particular embodiments, re-pricing of products in brick-and-mortar stores may enable brick-and-mortar retail locations to compete more effectively with online retail stores which may, for example, offer lower prices on particular products. In other embodiments, the system may enable brick-and-mortar retail stores to avoid reverse show-rooming by customer (e.g., avoid having customers come to the brick-and-mortar retail store, try out a particular product in person, and then order the particular product form an online retailer rather than purchasing it from the brick-and-mortar retail store).

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

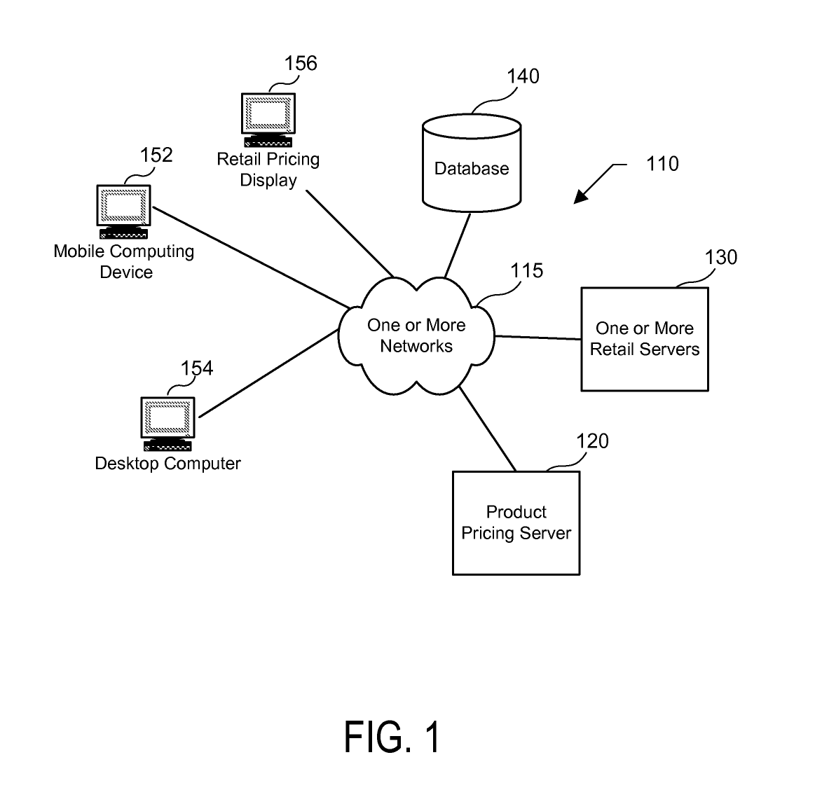

FIG. 1 is a block diagram of a System 110 according to a particular embodiment. As may be understood from this figure, the System 110 includes one or more computer networks 115, a Product Pricing Server 120, One or More Retail Servers 130, a Database 140, and one or more remote computing devices such as a mobile computing device 152 (e.g., such as a smart phone, a tablet computer, a wearable computing device, a laptop computer, etc.), a desktop computer 154, or an electronic Retail Pricing Display 156. In particular embodiments, the one or more computer networks 115 facilitate communication between the Product Pricing Server 120, One or More Retail Servers 130, the Database 140, and the one or more Remote Computing Devices 152, 154, 156.

In various embodiments, the electronic Retail Pricing Display 156 may comprise an electronic display (e.g., an L.E.D. display, a plasma display, LCD display, or any other suitable display) that is operatively coupled to a processor and memory. The electronic Retail Pricing Display 156 may also comprise a network module that is operatively coupled to the processor. The network module may be a wired network module, a wireless network module or any other suitable network module (e.g., near field Bluetooth module, etc.) that allows the system to operatively communicate with the electronic Retail Pricing Display 156. In various embodiments, the electronic Retail Pricing Display 156 contains a power source (e.g. a rechargeable battery, a replaceable battery, etc.) that provides a source of energy to the various electronic components of the electronic Retail Pricing Display 156.

The one or more Computer Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between Product Pricing Server 120 and Database 140 may be, for example, implemented via a Local Area Network (LAN) or via the Internet.

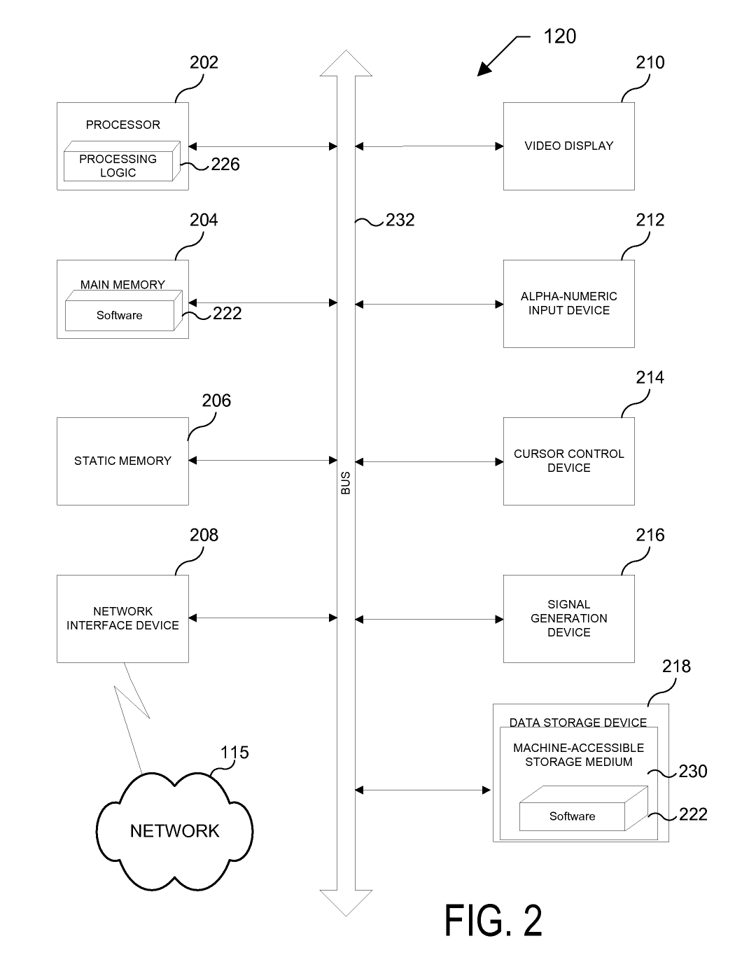

FIG. 2 illustrates a diagrammatic representation of a computer that can be used within the System 110, for example, as a client computer (e.g., one of the Remote Computing Devices 152, 154 shown in FIG. 1), or as a server computer (e.g., Product Pricing Server 120 shown in FIG. 1). In particular embodiments, the Computer 120 may be suitable for use as a computer within the context of the System 110 that is configured for collecting, tracking, and storing product pricing data.

In particular embodiments, the Computer 120 may be connected (e.g., networked) to other computers in a LAN, an intranet, an extranet, and/or the Internet. As noted above, the Computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein (e.g., Re-Pricing Module 300, Updating Pricing Module 400, and/or Factor-Based Re-Pricing Module 500). The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Platform

As noted above, a system for re-pricing one or more products according to various embodiments is adapted to perform a variety of different functions relating to re-pricing. Exemplary functionality of certain embodiments of the system is described below.

Re-Pricing Module

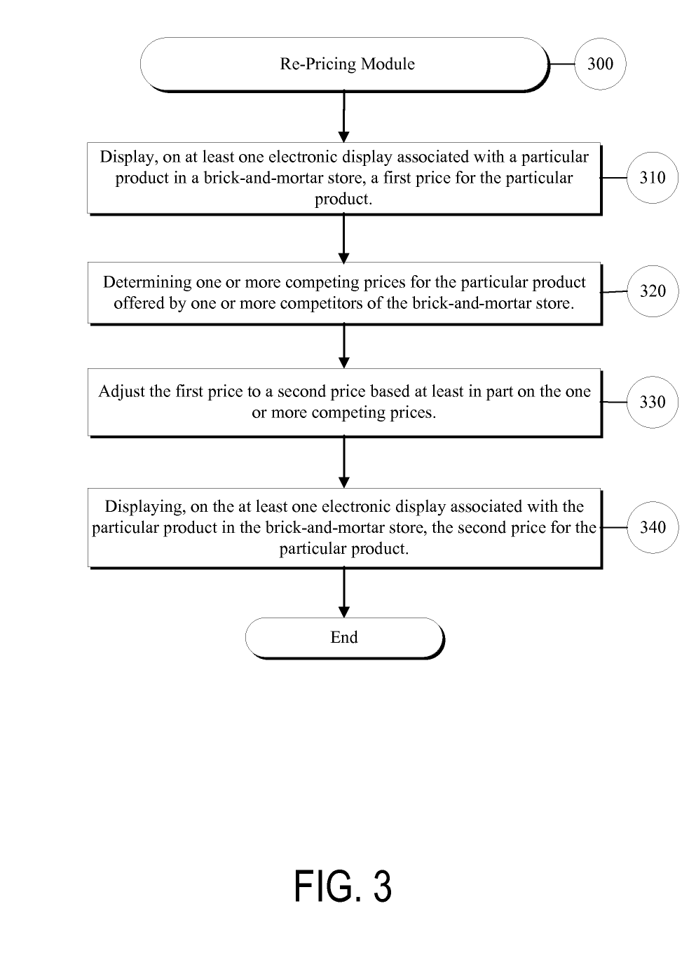

FIG. 3 is a flow chart of operations performed by an exemplary Re-Pricing Module 300, which may, for example, run on the Product Pricing Server 100, or any other suitable computing device (such as a suitable mobile computing device). In particular embodiments, the Re-Pricing Module 300 may facilitate adjusting and displaying a new price for a particular product.

In various embodiments, the system begins at Step 310 by displaying, on an electronic display associated with a particular product in a brick-and-mortar retail store, a first price for the particular product. In particular embodiments, the system may be configured to display the first price on any suitable display. In various embodiments, the display may be attached to the particular product. For example, the display may be an electronic tag attached to a product such as a pair of shoes. In particular embodiments, the display may be substantially adjacent to the particular product. In various embodiments, the first price may be any number value and may be in any form of currency. For example, the first price on the display attached to the pair of shoes may be $100. In various embodiments, the display may be a smart electronic display that is operatively coupled to the system via a wired or wireless connection.

At Step 320, the system determines one or more competing prices for the particular product. In various embodiments, the system determines the one or more competing prices by receiving product listings from online retail websites for competitors. The system then determines, based at least in part on one or more matching criteria, which of the product listings are for the particular product. The matching criteria may be a match based on the type of product, the genre of the product, the product's SKU, the brand of the product, or the features of the product, etc. At least partially in response to determining which of the product listings are for the particular product, the system determines the one or more competing prices from the product listings for the particular product. For example, the system may receive product listings for a pair of Nike® Air Max shoes from two online retail websites, Amazon® and Zappos®, where the price on Amazon® is $95 and the price on Zappos® is $105.

In various embodiments, the system may match the model number, size, color, SKU, etc. to the particular product in order to ensure that the one or more competing prices are for a substantially similar product. In still other embodiments, the system may be configured to determine that the one or more competing prices for the particular product are for a similar product, but not for the exact same product. For example, the system may determine that the one or more competing prices are for the same shoe, but for a different color and/or a different size. In various embodiments, even though the competing price is for the same shoe, the system may determine that the competing price does not correspond to the particular product since the competing price is associated with a shoe of a different color (e.g., the competing price is for the same shoe in a more popular color that sells better than the particular product). In other embodiments, the system may compare the SKU associated with the product for the competing price to the SKU for the particular product. In such embodiments, the system may determine that a competing price for a product is a match to the particular product when the SKUs for each product match.

At Step 330, the system is configured to adjust the first price for the particular product to a second price based at least in part on the one or more competing prices for the particular product. For example, in some embodiments, the system may adjust the price for the particular product to match the lowest detected competing price. In other embodiments, the system may adjust the price for the particular product to match the lowest detected competing price among a list of specific competitors. In still other embodiments, the system may adjust the price for the particular product to be one penny lower than the lowest competing price or the lowest competing price among a list of specific competitors. In yet other embodiments, the system may adjust the price for the particular product to match the lowest detected price among competitors located in a specified geographic area. In various embodiments, the second price may be higher than the first price. In particular embodiments, the second price may be lower than the first price. In other embodiments, the second price may be equal to the first price. For example, if the first price for the pair of Nike® Air Max shoes is $100 and the competing prices are $95 at Amazon® and $105 at Zappos®, the system may adjust the first price from $100 to a second price of $95.

In various embodiments, the system may adjust the first price to the second price according to a predetermined schedule. The predetermined schedule may be any suitable schedule including a particular schedule for holidays, a daily schedule, a weekly schedule, a monthly schedule, an hourly schedule, or a schedule by the minute. For example, the system may schedule to adjust the first price to the second price once a week on Fridays based on the one or more competing prices received during that week. In other embodiments, the system may adjust the first price to the second price substantially continuously. For example, once the system adjusts the first price to the second price, the system may then adjust the second price continuously until the product is sold.

At Step 340, the system displays, on the display associated with the particular product in the brick-and-mortar retail store, the second price for the particular product. In various embodiments, the system will substantially automatically display the second price for the particular product. For example, after adjusting the first price from $100 to $95 for the Nike® Air Max shoes, the system will display $95 on the display associated with the shoes, such as an electronic tag attached to the shoes or an electronic tag attached to a shelf on which the shoes are being displayed.

Updating Re-Pricing Module

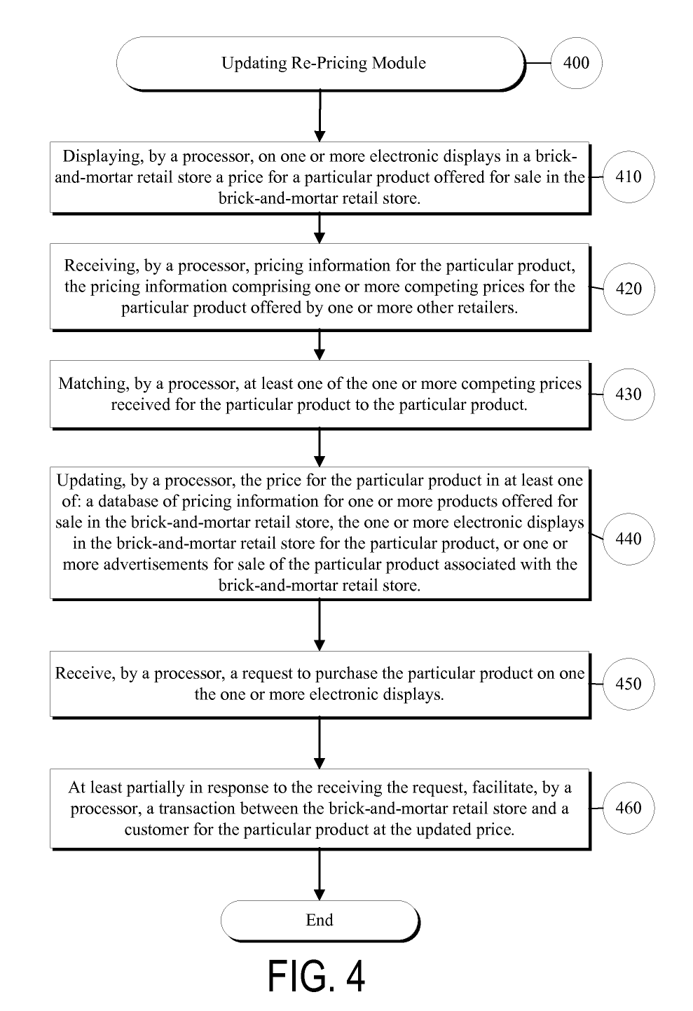

FIG. 4 is a flow chart of operations performed by an exemplary updating re-pricing module 400, which may, for example, run on the product pricing server 120, or any other suitable computing device. In particular embodiments, the Updating Re-Pricing Module 400 may adjust a price for a particular product.

Beginning at Step 410, the system displays, by a processor, on one or more electronic displays in a brick-and-mortar retail store, a price for a particular product offered for sale in the brick-and-mortar retail store. In particular embodiments, the system may be configured to display the price on any suitable display. In various embodiments, the display may be attached to the particular product. For example, the one or more displays may be an electronic tag attached to a product such as a pair of shoes. In particular embodiments, the one or more displays may be positioned substantially adjacent to the particular product. In still other embodiments, the one or more displays may be any size, relatively big or relatively small, or any size in between. In various embodiments, the price may be any numeric value and may be in any form of currency. For example, the price on the display attached to the pair of shoes may be $100.

At Step 420, the system receives, by a processor, pricing information for the particular product, the pricing information including one or more competing prices for the particular product. In various embodiments, the pricing information for the particular product is received from the manufacturer of the particular product. In particular embodiments, the pricing information for the particular product is received via the Internet. In various embodiments, the system determines the competing prices by receiving one or more product listings from one or more online retail websites. The system then determines, based at least in part on one or more matching criteria, which of the product listings from the online retail websites are for the particular product. The matching criteria may include, for example, the type of product, the genre of the product, the brand of the product, or one or more product features, a product SKU, etc. In various embodiments, at least partially in response to determining which of the product listings are for the particular product, the system determines the one or more competing prices from the product listings for the particular product. For example, the system may receive product listings for a pair of Nike® Air Max shoes from two online retail websites, Amazon® and Zappos®, where the price on Amazon® is $95 and the price on Zappos® is $105.

Next, at Step 430, the system adjusts, by a processor, the price for the particular product based at least in part on the one or more competing prices. For example, where the competing prices for the particular product priced at $100 are $95 and $105, the system may adjust the price for the particular product higher or lower than the current price depending upon the competing prices. In other embodiments, the system may be configured to adjust the price based on one or more predetermined criteria. For example, in some embodiments, the system may adjust the price for the particular product to match the lowest detected competing price. In other embodiments, the system may adjust the price for the particular product to match the lowest detected competing price among a list of specific competitors. In still other embodiments, the system may adjust the price for the particular product to be one penny lower than the lowest competing price or the lowest competing price among a list of specific competitors. In yet other embodiments, the system may adjust the price for the particular product to match the lowest detected price among competitors located in a specified geographic area. For example, the system may adjust the price for the particular product a plurality of times until the product is sold.

At Step 440, the system updates the price for the particular product, for example, in at least one of the following ways: (1) the system updates a database of pricing information to reflect the change in pricing for one or more products offered for sale in the brick-and-mortar retail store; (2) the system updates the pricing information to reflect the change in pricing on one or more electronic displays in the brick-and-mortar retail store; or (3) the system updates the pricing in one or more advertisements for sale of the particular product associated with the brick-and-mortar retail store to reflect the change in pricing. In particular embodiments, the system may update the price for the particular product substantially automatically. The database of pricing information may contain the updated price as well as one or more the previous prices for the particular product based on the date the price change occurred. The electronic display in the brick-and-mortar retail store may contain the updated price and the previous price in a manner that indicates that the updated price is different than the previous price. For example, the display may contain the updated price in a particular color, such as red, and the previous price shown with a strikethrough, indicating that the updated price is lower than the previous price.

In some embodiments, the system may monitor one or more competitor websites to detect changes in competing pricing for the particular products. In various embodiments, the system may monitor the one or more competitor websites at a particular interval (e.g., hourly, daily, weekly, monthly, substantially continuously, etc.). In some of such embodiments, when a change in a competition price occurs, the system may be configured to update the pricing in a database of pricing information for one or more products offered for sale in the brick-and-mortar retail store. In various embodiments, the system may adjust the price in the database as the changes are detected.

In various embodiments, the system may analyze one or more price patterns for one or more products and project when price changes may occur. In some such embodiments, the system may automatically update the price for a particular product prior to detecting a current price change based on the predicted price change calculated by the system. In this way, the system may provide the brick-and-mortar stores with an advantage of having the lower price for a particular product prior to one or more competitors lowering their prices for the particular product.

Continuing at Step 450, the system receives a request to purchase the particular product at the brick-and-mortar retail store on one of the one or more electronic displays. For example, the system may include a touch screen on the one of the one or more electronic displays for allowing a customer to send a request to purchase the particular product to the store's checkout system. At Step 460, the system, at least partially in response to receiving the request, facilitates, by a processor, a transaction between the brick-and-mortar retail store and a customer for the particular product at the updated price. For example, after receiving the request to purchase the particular product, the system may allow the customer to enter payment information into the one of the one or more electronic displays in order to complete the transaction. In particular embodiments, where the electronic display is attached to the particular product, the system may disengage the electronic display from the particular product enabling the customer to carry the particular product out of the brick-and-mortar retail store. In various embodiments, the touch screen may include a magnetic card reader that would allow the customer to purchase the item. The system may be configured to send an electronic receipt to the customer's e-mail account. In some of these embodiments, the customer, after making the purchase request, may pick the product up at a window where purchased items are delivered in advance of the customer leaving the store.

Factor-Based Re-Pricing Module

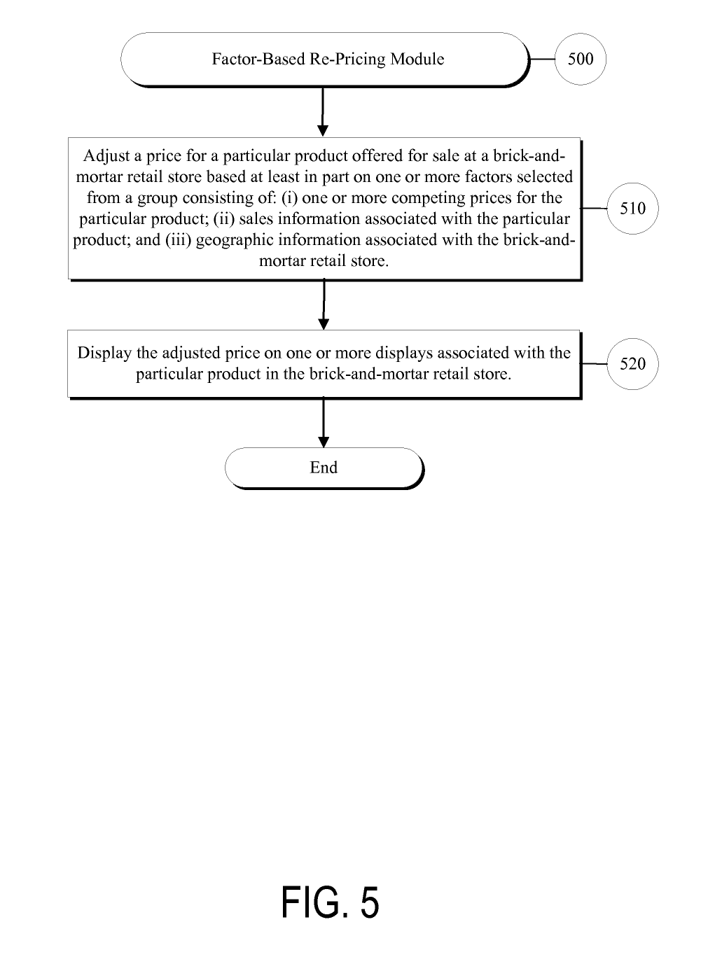

FIG. 5 is a flow chart of operations performed by an exemplary Factor-Based Re-Pricing Module 500, which may, for example, run on the Product Pricing Server 120, or any other suitable computing device. In particular embodiments, the Factor-Based Re-Pricing Module 500 adjusts a price for a particular product based, at least in part, on at least one factor.

At Step 510, the system adjusts a price for a particular product offered for sale at a brick-and-mortar retail store based at least in part on one or more factors selected from a group consisting of: (1) one or more competing prices for the particular product; (2) sales information associated with the particular product; and (3) geographic information associated with the brick-and-mortar retail store. In various embodiments, the one or more competing prices for the particular product may be received from one or more online retailers. That is, the system may be configured to scan one or more online retail outlets for similar products and their associated pricing.

In particular embodiments, the sales information associated with the particular product may be received directly or indirectly from the manufacturer of the particular product. For example, the sales information may contain manufacturer suggested retail price information, regional price information and/or regional or national promotional price information. In various embodiments, the geographic information associated with the brick-and-mortar retail store may be received from one or more geolocation devices such as GPS sensors, which may be used by the system to determine the location of the particular items being sold. In some such embodiments, the GPS sensors may be located in the one or more electronic displays. In various embodiments, the geographic information associated with the brick-and-mortar retail store may be obtained from the Internet or other source, such as from a database of phone numbers or other suitable source. That is, the system may use the brick-and-mortar address to determine the geographical location in which the store resides. The system may then obtain competitive pricing information for one or more products from other retailers located in the same geographical location. This information may be stored in local memory or stored in a central database (e.g., database 140).

At Step 520, the system displays the adjusted price on one or more electronic displays associated with the particular product in the brick-and-mortar retail store. In various embodiments, the system may store computer-executable instructions for displaying the one or more competing prices for the particular product on the one or more electronic displays.

### User Experience

Re-Pricing—User Experience

The following describes an exemplary user experience associated with the re-pricing of products. In this embodiment, the system displays a first price for a particular product, determines a competing price for the product, adjusts the first price to a second price, and then displays the second price for the product. In a particular example, a manager of a brick-and-mortar retail store may oversee installation of a plurality of electronic displays along each aisle of the brick-and-mortar retail store. The manager may then use the system to associate particular displays with particular products that are placed on the store's shelves. The store manager may then use the system to create one or more pricing rules for the particular products for adjusting a price of the particular products based on competing prices for the particular product. The manager may, for example, provide the system with a pricing rule that the system is to use to re-price the particular products according to a pre-determined schedule (e.g., every evening) to match the lowest known competing price for the respective particular product (e.g., as determined via a suitable Internet search).

In this example, the system may, for example, be configured to receive one or more competing prices for the particular product every evening, determine the lowest competing price for the particular products, and adjust (e.g., automatically) the price of the particular products to match the lowest competing price. The system may be configured to display the adjusted price on the electronic displays at the retail store associated with the respective particular products.

Updating Re-Pricing—User Experience

The following describes an exemplary user experience with the updating of pricing. In this embodiment, the system displays a price for a particular product, receives one or more competing prices for the product, adjusts the price for the product based on the competing prices, and updates the price for the product in one or more of the following: a database of pricing information for the products in the brick-and-mortar retail store, one or more display in the brick-and-mortar retail store, or one or more advertisement associated with the brick-and-mortar retail store. For example, the system may have the price for a pair of shoes listed as $100 on the display. After determining that a competitor is selling the same shoes on-line for $90, the system automatically adjusts the price to match the competitor's price. The system then updates the price for the shoes in the brick-and-mortar retail store's advertisements for those shoes such that the next advertisements sent out to the public or presented on a website will include the updated price of $90. The one or more advertisement may be updated, for example, by adjusting the price in advertisements displayed on the retailer's website, or automatically sending updated pricing information to print advertisers (e.g., newspaper advertisers, print flyers, etc.). In this way, the advertising provider can update the listed pricing in print and electronic advertising as the price changes in the retail store.

Factor-Based Re-Pricing—Experience

The following describes an exemplary user experience associated with Factor-Based Re-Pricing. In this embodiment, the system adjusts a price for a particular product offered for sale in a brick-and-mortar retail store based on one or more factors including one or more competing prices, sales information for the product, and geographic information for the store. At least partially based on the one or more factors, the system updates one or more displays, associated with the particular product, with the adjusted price. For example, the system may determine that a brick-and-mortar retail store is located in Georgia by using a geolocation of the brick-and-mortar retail store (e.g., based on the store's address, on a GPS sensor, etc.). Based, at least in part, on the geographic information for the store (i.e., Georgia), the system may determine that a particular product such as a pair of shoes should be sold for a lower price than the same shoes for sale in Texas. Based on the geographic location, the system adjusts the price for the shoes for sale in Georgia and adjusts the price shown on an electronic display associated with the shoes in the brick-and-mortar store in Georgia.

In various embodiments, the system may be configured to track one or more pricing trends for a particular product. The system may use the one or more pricing trends to predict when pricing for the particular product is likely to change (e.g., either go up or go down). In some such embodiments, the system may be configured to predict when a price for a particular product will change, and change the particular product pricing prior to the change occurring at competitor retail stores. In this way, the brick-and-mortar store can gain a pricing advantage over other retail stores by offering lower prices prior to their competitors.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. For example, although various embodiments are described above as being adapted to re-price items in brick-and-mortar retail stores, in other embodiments, the system may be adapted to re-price (e.g., automatically re-price) items that are for sale in an ecommerce context (e.g., by re-pricing one or more items on one or more retail websites). Although specific terms are employed herein, they are used in a generic and descriptive sense only and not for the purposes of limitation.

What is claimed is:

1. A computer system comprising:
a. at least one processor; and
b. at least one electronic display operatively coupled to the at least one processor, wherein the computer system is configured for:
i. displaying, on the at least one electronic display associated with a particular product in a brick-and-mortar store, a first price for the particular product;
ii. determining one or more competing prices for the particular product offered by one or more competitors of the brick-and-mortar store;
iii. adjusting the first price to a second price based at least in part on the one or more competing prices; and
iv. displaying, on the at least one electronic display associated with the particular product in the brick-and-mortar store, the second price for the particular product.

2. The computer system of claim 1, wherein the computer system is further configured for adjusting the first price to the second price according to a predetermined time schedule.

3. The computer system of claim 1, wherein adjusting the price of the particular product further comprises substantially continuously:
a. monitoring the pricing of the particular product at a website for the one or more competitors; and
b. updating the price of the particular product in a database of pricing information in accordance with one or more predetermined criteria.

4. The computer system of claim 1, wherein determining the one or more competing prices for the particular product comprises:
a. receiving a plurality of product listings from a plurality of online retail websites;
b. determining, based at least in part on one or more matching criteria, which of the plurality of product listings are for the particular product; and
c. at least partially in response to determining which of the plurality of product listings are for the particular product, selecting the one or more competing prices from the product listing for the particular product.

5. The computer system of claim 1, wherein the computer system is further configured for:
a. tracking the one or more competing prices over time for the particular product;
b. determining price change trends for the particular product over time;
c. predicting price changes for the particular product at least partially based on the determined price change trends; and
d. adjusting the second price to a predicted price prior to actual changes in competitor pricing.

6. The computer system of claim 1, wherein adjusting the first price to a second price further comprises updating the first price to the second price in a pricing database.

7. The computer system of claim 1, wherein displaying the second price for the particular product further comprises:
a. wirelessly transmitting the second price to the at least one electronic display; and
b. at least partially in response to wirelessly transmitting the second price, receiving the second price at the at least one electronic display via a wireless transmitter operatively coupled to the at least one electronic display.

8. A computer-implemented method of adjusting a price for a particular product displayed on one or more electronic displays that are operatively coupled to a system that monitors prices for products sold in a brick-and-mortar retail store, the method comprising:
a. displaying, by one or more processors, on the one or more electronic displays in the brick-and-mortar retail store a price for a particular product offered for sale in the brick-and-mortar retail store;
b. receiving, by one or more processors, pricing information for the particular product, the pricing information comprising one or more competing prices for the particular product offered by one or more other retailers;
c. matching, by one or more processors, at least one of the one or more competing prices received for the particular product to the particular product; and
d. updating, by one or more processors, the price for the particular product in at least one of:
(i) a database of pricing information for one or more products offered for sale in the brick-and-mortar retail store;
(ii) the one or more electronic displays in the brick-and-mortar retail store for the particular product; or
(iii) one or more advertisements for sale of the particular product associated with the brick-and-mortar retail store.

9. The computer-implemented method of claim 8, further comprising automatically updating, by one or more processors, the price for the particular product on the one or more electronic displays based, at least in part, on the matched at least one of the one or more competing prices.

10. The computer-implemented method of claim 8, wherein updating the price of the particular product further comprises substantially continuously:
a. monitoring, by one or more processors, the pricing of the particular product at one or more competing retailers' website; and
b. updating, by one or more processors, the price of the particular product in the database of pricing information in accordance with one or more predetermined criteria.

11. The computer-implemented method of claim 8, wherein matching at least one of the one or more competing prices received for the particular product to the particular product further comprises:
a. comparing, by one or more processors, at least one attribute selected from a group consisting of (i) a model number of the competing product, (ii) a size of the competing product, (iii) a color of the competing product, (iv) a style of the competing product, (v) a genre of the competing product, (vi) a brand of the competing product, (vii) a geographic location of the competing product, and (viii) stock-keeping unit (SKU) number of the competing product to at least one similar attribute of the particular product; and
b. selecting, by one or more processors, at least one product associated with the respective one or more competing prices that best matches the at least one similar attribute of the particular product.

12. The computer-implemented method of claim 8, further comprising the steps of:
a. tracking, by one or more processors, competing prices over time for the particular product;
b. determining, by one or more processors, one or more price change trends for the particular product over time;
c. predicting, by one or more processors, one or more price changes for the particular product at least partially based on the determined one or more price change trends; and
d. adjusting, by one or more processors, the updated price on the or more electronic displays to a predicted price prior to an actual change in competitor pricing.

13. The computer-implemented method of claim 8, further comprising the step of automatically updating, by one or more processors, the one or more electronic displays in the brick-and-mortar retail store for the particular product based on the received one or more competing prices for the particular product until the particular product is sold.

14. The computer-implemented method of claim 8, wherein updating the price for the particular product on the one or more electronic displays further comprises displaying, by one or more processors, both the updated price and the price on the one or more electronic displays.

15. A computer system comprising at least one processor, wherein the computer system is configured for:
a. displaying, on the at least one electronic display associated with a particular product in a brick-and-mortar store, a first price for the particular product;
b. determining one or more competing prices for the particular product offered by one or more competitors of the brick-and-mortar store;
c. adjusting the first price to a second price based at least in part on the one or more competing prices; and
d. displaying, on the at least one electronic display associated with the particular product in the brick-and-mortar store, the second price for the particular product.

16. The computer system of claim 15, wherein the computer system is further configured for adjusting the first price to the second price substantially automatically.

17. The computer system of claim 15, wherein determining the one or more competing prices for the particular product comprises:
a. receiving a plurality of product listings from a plurality of online retail websites;
b. determining, based at least in part on one or more matching criteria, which of the received plurality of product listings are relevant to the particular product; and
c. at least partially in response to determining which of the plurality of product listings are relevant to the particular product, selecting the one or more competing prices for the particular product.

18. The computer system of claim 15, wherein adjusting the first price of the particular product to the second price further comprises updating the first price to the second price in a pricing database.

19. The computer system of claim 18, wherein adjusting the first price of the particular product to the second price further comprises:
a. substantially continuously monitoring the price of the particular product at one or more competing retailers; and
b. updating the price of the particular product in the database of pricing information in accordance with one or more predetermined criteria.

20. The computer system of claim 15, wherein the computer system is further configured for:
a. tracking one or more competing prices over time for the particular product;
b. determining a price change trend for the particular product;
c. predicting a price change for the particular product at least partially based on the determined price change trend; and
d. calculating the second price based on the predicted price change.
